(19) United States
(12) Patent Application Publication
(10) Pub. No.: US 2023/0001602 A1
(43) Pub. Date: Jan. 5, 2023

(54) GUIDE BAR FOR A CHAINSAW

(71) Applicant: Andreas Stihl AG & Co. KG, Waiblingen (DE)

(72) Inventors: Matthias Schulz, Freiberg/Neckar (DE); Thomas Lux, Alfdorf (DE); Martin Schlegl, Rudersberg (DE); Matthias Mueller, Schorndorf (DE); Georg Maier, Kernen (DE)

(21) Appl. No.: 17/850,589

(22) Filed: Jun. 27, 2022

(30) Foreign Application Priority Data
Jun. 30, 2021 (EP) 21182821.5

(51) Int. Cl. B27B 17/02

(52) U.S. Cl. CPC B27B 17/025

(57) ABSTRACT

A guide bar for a chainsaw has a middle section which forms a groove base of a guide groove. The middle section has an edge layer which includes at least one hardened region extending from a first end having a first edge layer depth to a second end having a second edge layer depth. The first edge layer depth at the first end is less than the second edge layer depth at the second end. The second edge layer depth at the second end is greater than 1 mm. The first edge layer depth at the first end of the hardened region is at most 3 mm.

### CROSS REFERENCE TO RELATED APPLICATION

This application claims priority of European patent application no. 21182821.5, filed Jun. 30, 2021, the entire content of which is incorporated herein by reference.

### TECHNICAL FIELD

The disclosure relates to a guide bar for a chainsaw. The guide bar has a clamping section and a free end with a redirection section located at the free end. The guide bar has two side elements which extend from the clamping section to the redirection section. The guide bar has a peripheral guide groove and a central section that is located between the side elements. The central section forms a groove base of the guide groove.

### BACKGROUND

Guide bars for chainsaws are subject to a high degree of wear during operation. In particular, run-in sections and the redirection section of the guide bar are subject to a high degree of wear due to the high mechanical load during operation. To reduce wear, it is known in the prior art to arrange a rotatably mounted redirect sprocket at the guide bar tip, on the redirection section. It is also known from EP 2 550 138 B1 to provide a hardened insert or the like at the guide bar tip. However, the construction of such bars is comparatively complex.

### SUMMARY

An object of the disclosure is to provide a guide bar that has a simple structure and reduced wear.

The guide bar for a chainsaw has a peripheral guide groove and a central section that is located between the side elements. The central section forms a groove base of the guide groove. The central section has an edge layer. The edge layer includes a hardened region. The hardened region extends from its first end having a first edge layer depth to a second end having a second edge layer depth. The first edge layer depth and the second edge layer depth are each measured orthogonally to the groove base.

The first edge layer depth corresponds to the distance between the groove base and the first end of the hardened region. The second edge layer depth corresponds to the distance between the groove base and the second end of the hardened region. The first edge layer depth of the hardened region at the first end is less than the second edge layer depth of the hardened region at the second end. The second edge layer depth of the hardened region at the second end is greater than 1 mm. The edge layer depth at the first end of the hardened region is at most 3 mm. The closer the hardened region is to the groove base, the greater is the resistance to wear, that is, the wear resistance. Accordingly, it is advantageous if the edge layer depth at the first end of the hardened region is at most 1.5 mm, particularly preferably at most 0.5 mm. It is particularly advantageous if the hardened region extends to the groove base of the guide groove.

When a chainsaw is in operation, the saw chain is usually supported on the guide surfaces of the guide bar by its connecting links. The drive links of the saw chain in this case are at a distance from the groove base. If there is wear on the guide surfaces, the distance between the drive links and the groove base can be reduced in such a manner that the drive links and the groove base come into contact. In this state, the saw chain rests via its drive links on the groove base, and via its connecting links on the guide surfaces of the guide bar. A hardened region realized in the edge layer of the groove base counteracts wear on the guide bar on the groove base. Since the saw chain rests with its drive links on the groove base, the forces acting upon the guide surfaces, and thus also the wear on the guide surfaces of the guide bar, are reduced. Thus, further deformation of the entire guide bar induced by wear can be avoided, or at least reduced.

The at least one hardened region is preferably induction hardened or laser hardened. In the case of such a manner of hardening, the material is heated to a temperature of about 900° C. to 1000° C. This causes austenitization of the structure. The guide bar is then quenched, which effects a transformation of the austenitic structure into a martensitic structure. A martensitic structure has a significantly greater hardness than the initial structure, thereby also increasing the wear resistance.

In an alternative embodiment of the guide bar, the hardness increase of the at least one hardened region is preferably effected by a weld of the guide bar. The advantage of the weld is that it can be used to assemble a multi-part guide bar and at the same time to partially harden it. The weld has a weld center spot. Particularly advantageously, the weld center spot of the weld is at a distance of less than 6 mm from the groove base. It is thus ensured that the region whose hardness is increased by the weld is sufficiently close to the groove base of the guide bar to increase the wear resistance of the bar.

It is preferably provided that the edge layer has an edge layer depth measured orthogonally to the groove base, the edge layer depth being less than 50%, in particular less than 40%, preferably less than 30% of a maximum height of the central section of the guide bar. The maximum height corresponds to the maximum distance between the groove base on the first longitudinal side and the groove base on the second longitudinal side of the guide bar. The distance is to be measured in the direction perpendicular to the longitudinal center axis. The region of the central section radially inside the edge layer is preferably unhardened, in particular completely unhardened.

The guide bar is preferably a solid bar. The solid bar is made of a single material. In the case of a solid bar, the side elements and the central section are realized as a single piece. The guide groove on the center section is to be machined, in particular milled, preferably ground, into the guide bar. Particularly large guide bars are usually realized as solid bars. Since, in the case of solid bars, the side elements and the central section do not have to be mounted, the hardened region in the edge layer of the groove base is preferably produced by laser hardening or induction hardening. Alternatively, hardening may also be effected via a weld. In this case, the function of the weld is reduced merely to increasing hardness, but no longer to joining individual guide bar parts that form, for example, the side elements and the central section of the guide bar.

Preferably, the guide bar is realized in a multipart form, at least one side element and the central section being connected to each other by the weld, the weld effecting the hardness increase of the at least one hardened region of the central section. Alternatively, both side elements and the central section may be joined together by the weld. Preferably, the weld is a projection weld, preferably a spot weld. If guide bars are to be produced in large quantities, projection welding is suitable due to its high process speed at low production costs. Preferably, the weld includes a plurality of welding spots, adjacent welding spots being spaced apart by a distance of at most 15 mm, in particular of at most 10 mm, preferably of at most 5 mm. The distance between adjacent welding spots relates to their weld center spots. Accordingly, the distance between adjacent welding spots is measured from the weld center spot of one welding spot to the weld center spot of the adjacent welding spot. The smaller the distance is between the individual welding spots, the more uniform is the hardness of the guide bar. Preferably, the welding spots have a constant distance from the guide groove. The distance between adjacent welding spots is to be measured in the movement direction of the saw chain provided on the guide bar. If the distance between adjacent welding spots is sufficiently small, a pronounced wave contour of the guide bar, due to the occurrence of wear, can be avoided. Alternatively, the weld may be a laser weld. This renders possible a particularly uniform, at least partial hardness increase of the edge layer of the central section. If the weld is embodied as a projection weld or a spot weld, the weld center spot is to be understood as the actual geometric mid-point of the weld. If the weld is realized as a laser weld, the weld center spot corresponds to the center between the first end and the second end of the hardened region, measured orthogonally to the groove base, in other words a center line of the weld seam.

It can advantageously be provided that the hardened region of the edge layer extends over a wear section in the movement direction of a saw chain that can be guided on the guide bar. Preferably, the guide groove of the guide bar has a first groove depth in the wear section, the first groove depth being reduced compared to a second groove depth provided outside of the wear section. The first groove depth is in particular adapted in such a manner that a saw chain provided for the guide bar contacts the groove base in the wear section with its drive links. Thus, even when the guide bar is in the delivery state, the saw chain is supported via the drive links on the groove base of the guide groove as well as via the connecting links on the guide surfaces of the side elements. The contact force exerted by the saw chain is thus also transmitted to the groove base, thereby relieving the guide surfaces. Deformation of the guide bar is thus counteracted already in the delivery state, and/or shortly after it.

Particularly preferably, the guide bar has a first longitudinal side and a second longitudinal side, there being realized on each side element a guide surface that extends along the longitudinal sides of the guide bar, the hardness of the guide surfaces being increased at least in the wear section. Thus, the wear resistance is also increased on the guide surfaces, thereby counteracting deformation of the entire guide bar. In particular, the drive links contact the groove base in the wear section at a point in time when the saw chain with its links is still resting on a zone of the guide surfaces hardened, in particular, by induction hardening.

Clearly, a hardness increase may be provided on a plurality of sections of the central section of the guide bar. The hardness increase according to the disclosure should be provided on all the regions of the guide bar that are particularly subject to wear. The edge layer of the central section therefore preferably has a plurality of hardened regions. Preferably, there is at least one hardened region realized on the redirection section of the guide bar. The redirection section of the guide bar is most subject to stress, in particular in the case of guide bars without a redirect sprocket.

It can advantageously be provided that the guide bar includes at least one run-in region and at least one run-out region. A run-in region is to be understood as the section of the guide bar in which the saw chain contacts the guide bar after not having previously been guided by the guide bar. Such a run-in region is provided, for example, at the clamping end of the guide bar, which is located directly adjacent to the drive sprocket. There is another run-in region on guide bars that have a redirect sprocket. The saw chain is guided, over the redirect sprocket, along the redirection section, and so is lifted away from guide surface of the side elements. As a result, the friction between the saw chain and the guide bar in the region of the redirection section is minimized. Immediately adjacent to the redirect sprocket in the movement direction of the saw chain, the saw chain makes contact with the guide bar. This section forms another run-in region of the guide bar, which is subject to high degree of wear stress. A run-out region is to be understood as the section of the guide bar in which the saw chain lifts away from the guide bar. Such a run-out region is located, for example, adjacent to the drive sprocket in the direction opposite to the movement direction of the saw chain. In the case of a guide bar having a redirect sprocket, there is a further run-out region provided adjacent to the redirect sprocket in the direction opposite to the movement direction of the saw chain. Preferably, there is a hardened region realized at least at one run-in region and/or at least at one run-out region. Clearly, hardened regions may be provided at all run-in regions and at all run-out regions.

### BRIEF DESCRIPTION OF THE DRAWINGS

The invention will now be described with reference to the drawings wherein:

FIG. 1 shows a schematic side view of a chainsaw with a guide bar arranged thereon;

FIG. 2 shows a side view of a guide bar known from the prior art;

FIG. 3 shows a schematic side view of a guide bar according to the disclosure that has a hardened region and a reduced groove depth in the redirection section;

FIG. 4 shows a schematic side view of a further embodiment of a guide bar that has a hardened region and a reduced groove depth outside of the redirection section;

FIG. 5 shows a schematic side view of an embodiment of a guide bar that has a redirect sprocket, having a hardened region and a reduced groove depth;

FIG. 6 shows a schematic side view of an embodiment of a guide bar as a solid bar, having a hardened region and a reduced groove depth in the redirection section;

FIG. 7 shows a schematic side view of an embodiment of a guide bar as a solid bar, having a hardened region and a reduced groove depth outside of the redirection section;

FIG. 8 shows a schematic, partial lateral representation of the hardened region of a guide bar; and,

FIG. 9 shows a schematic, partial cross-section of a hardened region of a guide bar along the section line in the direction of the arrows IX according to FIG. 3.

### DESCRIPTION OF THE PREFERRED EMBODIMENTS

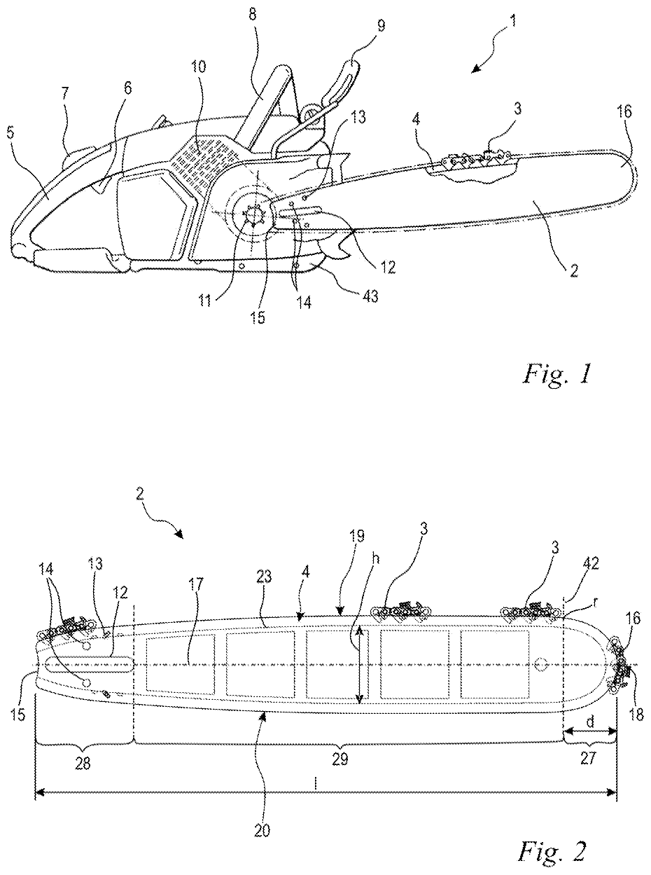

Shown schematically in FIG. 1 is a chainsaw 1 that has a guide bar 2. The guide bar 2 has a guide groove 4 in which a saw chain 3 is guided in a revolving manner. The saw chain 3 is guided over a drive sprocket 11, which during operation is driven in rotation by a drive motor 10 and thus moves the saw chain 3 in a revolving manner around the periphery of the guide bar 2. The drive motor 10 is represented schematically in FIG. 1 as an internal combustion engine. However, the drive motor 10 may also be an electric motor that is supplied with power from a battery or via a cable. The guide bar 2 has a clamping end 15 at which the guide bar 2 is fastened to a housing 43 of the chainsaw 1. The drive sprocket 11 is adjacent to the clamping end 15. The end of the guide bar 2 located away from the housing 43 forms a free end 16, at which the saw chain 3 is redirected. Near the clamping end 15, the guide bar 2 has a guide slot 12, through which there project clamping elements, not represented, by which the guide bar 2 is fixed to the housing 43 of the chainsaw 1. The guide bar 2 can advantageously have at least one, in the embodiment two, clamping openings 14, at which clamping means, not represented, for clamping the saw chain 3 can engage as a result of the guide bar 2 being moved relative to the housing 43. In the embodiment, the guide bar 2 also has at least one oil supply opening 13, via which lubricant such as oil can be introduced into the guide groove 4 from the outside of the guide bar 2.

For the purpose of guiding the chainsaw 1 during operation, the chainsaw 1 has a handle 5, on which operating elements are mounted. Operating elements may be, for example, a throttle lever 6 and a throttle lever lock 7. Also provided for the purpose of guiding the chainsaw 1 is a bale handle 8, which extends over the housing 43. Provided on the side of the bale handle 8 that faces toward the guide bar 2 there is hand protector 9, which may also serve to activate a chain braking device, not represented.

A guide bar 1 according to the disclosure may also be provided for other implements that have guide bars, for example pruners or pole pruners.

FIG. 2 shows the guide bar 2 in detail. The guide groove 4 has a groove base 23, which in FIGS. 2 to 8 is indicated by a dashed line. The guide bar 2 has a longitudinal center axis 17, which extends from the clamping end 15 to the free end 16 of the guide bar 2 in the geometric center of the guide bar 2. The guide bar 2 has a clamping section 28, which extends out from the clamping end 15, along the guide slot 12, to the longitudinal section 29 of the guide bar 2. The guide slot 12 in this case may be closed toward the clamping end 15, as represented in FIG. 2, or open toward the clamping end 15. The clamping openings 14 are also located in the clamping section 28. Advantageously, the at least one oil supply opening 13 is also located in the clamping section 28. The clamping section 28 ends at the end of the guide slot 12 that faces toward the free end 16 of the guide bar 2.

The guide bar 2 has a first longitudinal side 19 and a second longitudinal side 20, along which the guide groove 4 runs. On the first longitudinal side 19, the saw chain 3, during operation, moves from the clamping end 15 to the free end 16, and on the second longitudinal side 20 the saw chain 3, during operation, moves from the free end 16 to the clamping end 15. In FIG. 2 and in the following illustrations, the saw chain is represented only in part, in the interest of clarity. A redirection section 27 extends at the free end 16 of the guide bar 2. The guide bar 2 has a guide bar tip 18. The guide bar tip 18 is the region in which, in the side view represented in FIG. 2, the longitudinal center axis 17 intersects the redirection section 27. The side view represented in FIG. 2 is a view perpendicular to the flat side of the guide bar 2. The redirection section 27 extends, in the direction of the longitudinal center axis 17, from the guide bar tip 18 to a plane 42. The plane 42 is the notional plane that is perpendicular to the longitudinal center axis 17 and that, in the side view of the flat side of the guide bar 2, as shown in FIG. 2, passes through the point in which the outer contour of the guide bar 2 has a radius r of 100 mm. In the redirection section 27 the radius r is less than 100 mm. In the direction of the longitudinal center axis 17, the longitudinal section 29 runs between the redirection section 27 and the clamping end 28. In the longitudinal section 29, the radius r of the outer contour of the guide bar 2 is greater than 100 mm. The redirection section 27 can preferably extend over a length d, which is measured parallel to the longitudinal center axis 17 and which is preferably between 5% and 20% of the total length l of the guide bar 2. The total length 1 in this case is measured parallel to the longitudinal center axis 17. The longitudinal sides 19 and 20 extend, both in the longitudinal section 29 and in the clamping section 28, on the periphery of the guide bar 2. The periphery of the guide bar 2 in the redirection section 27 connects the two longitudinal sides 19 and 20.

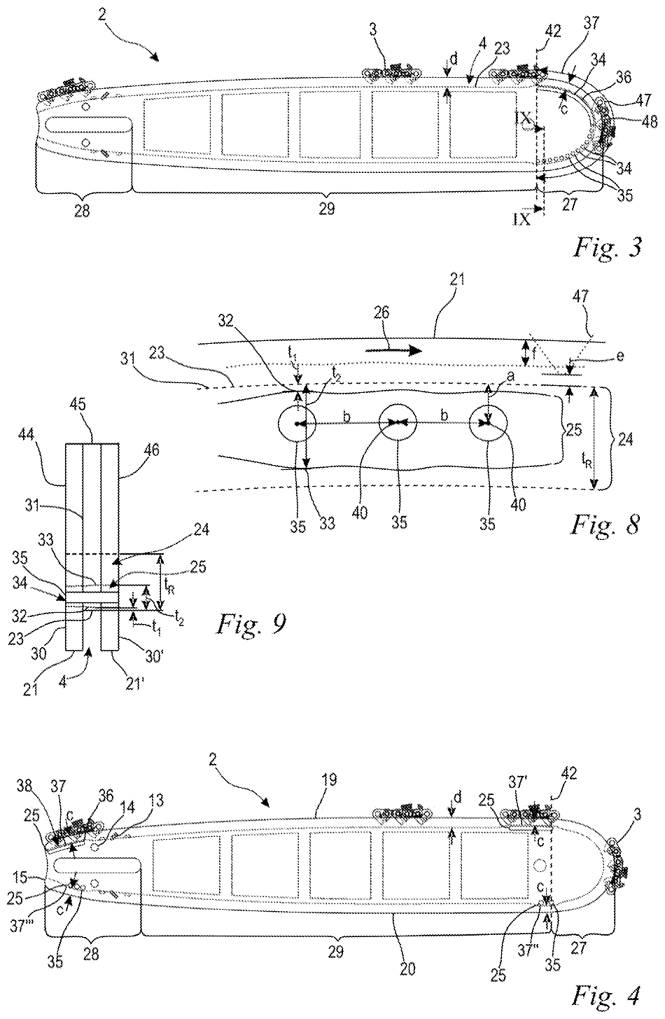

FIG. 3 shows a schematic side view of the guide bar 2 as a three-part guide bar. FIG. 9 shows a schematic cross-section of such a three-part guide bar 2. This includes a first side plate 44, a second side plate 46, and a central plate 45 located between the first side plate 44 and the second side plate 46. The side plates 44, 46 thus form two side elements 30, 30′ of the guide bar 2, the central plate 45 forming a central section 31 of the guide bar 2. In the embodiment, the first side plate 44, the second side plate 46 and the central plate 45 are connected to each other via welds 4. As shown in FIG. 9, there is a guide surface 21,21′ realized on the peripheral contour of each side element 30, 30′. The first side element 30 with its inner side delimits a first groove side of the guide groove 4. The first side element 30 includes the first guide surface 21, on its outer periphery. The second side element 30′ with its inner side delimits a second groove side of the guide groove 4. The second side element 30′ includes the second guide surface 21′, on its outer periphery. The groove base 23, which extends from the first side element 30 to the second side element 30′, is formed by the central section 31. In the embodiment, the welds 34 extend over the entire width of the guide bar 2. Alternatively, the welds 34 may also extend from only one of the two side elements 30, 30′ to the central section 31.

In a further alternative configuration of the guide bar, it may be provided that the central section 31 is realized as a single piece with one of the side elements 30, 30′ and is connected to the other side element 30, 30′ via the weld 34. Alternatively, it may also be provided that the central section 31 is composed of a plurality of parts, with one part of the central section 31 being realized as a single piece with one side element 30 and another part of the central section 31 being realized as a single piece with the other side element 30′, the two side elements 30, 30′ being connected to each other via welds 34.

As shown in FIG. 3, the side elements 30, 30′ are joined to the central section 31 via a plurality of welds 34. In the embodiment, the welds 34 are located in the redirection section 27. In an embodiment, the welds 34 are embodied as projection welds. Also, alternatively, the welds 34 may be spot welds. In a further configuration of the guide bar 2, the weld 34 may also be effected by laser welding. Other welding methods may also be used to join the guide bar 2. In FIG. 3, the possibility of using different welding methods is indicated schematically in the redirection section 27. Shown in the upper half of the guide bar 2 is a weld seam 36 produced, for example, by laser welding, and shown in the lower half of the guide bar 2 are individual welding spots 35 produced, for example, by projection welding or spot welding. In the case of such welds 34, the process of increasing the hardness the central section 31 is preferably effected at a distance from the groove base 23, in the direction toward the groove base 23. The guide bar 2 is preferably joined via only one method.

As shown in FIGS.s 8 and 9, there is a hardened region 25 realized on the central section 31. This hardened region 25 lies within an edge layer 24 of the central section 31. The edge layer 24 extends out from the groove base 23 of the central section 31 over an edge layer depth t_{R}. The edge layer depth t_{R} is measured orthogonally to the groove base 23. In the embodiment, the edge layer depth t_{R} is less than 50%, in particular less than 40%, preferably less than 30% of a maximum height (h) of the groove base 31 of the guide bar 2. The maximum height h corresponds to the maximum distance between the groove base 23 on the first longitudinal side 19 and the groove base 23 on the second longitudinal side 20 of the guide bar 2. The distance is to be measured in the direction perpendicular to the longitudinal center axis 17. The region of the central section 31 radially inside the edge layer 24 is preferably unhardened, in particular completely unhardened. In an alternative embodiment of the guide bar 2, other edge layer depths t_{R} may also be expedient.

The weld 34 causes a hardness increase, with respect to the base material of the central section 31, that extends out from the weld zone over a zone of influence. The weld zone and the zone of influence together form the hardened region 25. The weld causes local melting of the center section 31 and the side elements 30, 30′, resulting in a mixed structure in the weld zone. The temperature that prevails in this case results in austenitization in the weld zone. Since the weld zone is relatively small in relation to the guide bar 2, it cools down rapidly, due to the material surrounding the weld zone, as well as the ambient air. This process causes a quenching of the weld, which favors the generation of a martensitic microstructure. No molten pool is formed in the zone of influence, yet the temperature is sufficiently high to produce a transformation hardening according to the above principle. It may be expedient to perform a targeted quenching via an oil bath or a water bath. In the preferred embodiment, the quenching is effected by compressed air. Accordingly, the guide bar 2 is cooled by compressed air after hardening.

Preferably, the central section 31 of the guide bar 2 is made of a material different from that of the side elements 30, 30′. The central section 31 is preferably made of a low-carbon steel, in particular from a DC01, or carbon-free steel, such that the central section 31 has a greater elasticity and ductility compared to the side elements 30, 30′. The side elements 30, 30′ are preferably made of a quenched and tempered steel with a high carbon content, in particular 50CrMo4. The fusion of the central section 31 with the side elements 30, 30′ at the welding zone causes the materials to mix, as a result of which sufficient carbon is also present at the central section 31 in the weld zone, such that there can be a formation of martensite in the central section 31.

The hardened region 25 is represented schematically in FIGS. 8 and 9. The hardened region 25 extends, in a direction orthogonal to the groove base 23, from a first end 32 to a second end 33. The hardened region 25 lies entirely within the edge layer 24 of the central section 31. The hardened region 25 has an edge layer depth t₁ at its first end 32, measured orthogonally to the groove base 23. In addition, the hardened region 25 has an edge layer depth t₂ at its second end 33, measured orthogonally to the groove base 23. The edge layer depth t₁ at the first end 32 of the hardened region 25 is less than the edge layer depth t₂ at the second end 33 of the hardened region 25. In the embodiment, the hardened region 25 is realized in such a manner in the edge layer 24 that the edge layer depth t₁ at the first end 32 of the hardened region 25 is at most 3 mm, in particular at most 1.5 mm, preferably at most 0.5 mm. In a particularly preferred embodiment of the guide bar 2, the edge layer depth t₁ at the first end 32 of the hardened region 25 has the value zero. Accordingly, the first end 32 of the hardened region 25 is located at the groove base 23. Furthermore, the hardened region 25 is realized in such a manner in the edge layer 24 that the edge layer depth t2 at the second end 33 of the hardened region 25 is at least 1 mm, in particular at least 5 mm, preferably at least 10 mm. The edge layer depth t2 at the second end 33 of the hardened region 25 is at most the edge layer depth t_{R} of the edge layer 24.

As shown in FIG. 8, the weld 34 has a weld center spot 40. A distance a is provided between the weld center spot 40 and the groove base 23. The distance a is preferably less than 6 mm. In a particularly preferred embodiment of the guide bar 2, the distance a between the groove base 23 and the weld center spot 40 is less than 5 mm, in particular less than 4 mm, advantageously less than 3 mm. The smaller the selected distance a between the weld center spot 40 and the groove base 23, the smaller the distance is between the hardened region 25 and the groove base 23. The distance a between the weld center spot 40 of the weld 34 and the groove base 23 is to be selected so that the hardened region extends as far as possible to the groove base 23. However, the weld zone in this case should not include parts of the groove base 23, as this would otherwise lose its shape contour due to the molten bath. In this case, it might even be necessary to rework the guide bar 2.

As shown in FIG. 8, the weld 34 is composed of a plurality of welding spots 35. The welding spots 35 are located along the movement direction 26 of the saw chain 3. Such welding spots 35 may be produced, in particular, in projection welding or in spot welding. Adjacent welding spots 35 are spaced apart from each other by a distance b between their weld center spots 40, the distance b being at most 15 mm, in particular at most 10 mm, preferably at most 5 mm. As the distance b decreases, the hardening process becomes more uniform, that is, the boundary lines at the ends 32, 33 of the hardened region 25 become more uniform. This has the advantage that when the guide bar 2 is worn, the groove base 23 retains a comparatively uniform structure, and a pronounced wave structure of the groove base 23 can be avoided. This is advantageous for the running properties of the guide bar 2. Furthermore, in the case of the weld 34, in particular in the case of a projection weld, the current intensity can be reduced, or adapted, in such a manner that the diameter of the welding spots 35 is reduced. As a result, the distance b between adjacent welding spots 35 can be reduced, and the distance a between the welding center spots and the groove base can also be reduced. Consequently, the boundary lines at the ends 32, 33 of the hardened region 25 can be further smoothed. If the weld 34 is realized in the form of a single weld seam 36, for example by a laser welding process, the result is a uniformly extending boundary line of the hardened region 25. If a plurality of weld seams 36 are provided, the distances between adjacent weld seams 36 should preferably be selected in a manner similar to the distances between adjacent welding spots 35. As shown in FIG. 3, the weld 34, and thus also the hardened region 25, extends over the entire redirection section 27 of the guide bar.

As shown in FIGS. 3 and 4, the guide groove 4 has a first groove depth c and a second groove depth d. In the preferred embodiment, the guide groove 4 of the guide bar 2 has a first groove depth c that is at least partially adapted in such a manner that a saw chain 3 provided for the guide bar 2 in the delivery state contacts, or at least almost contacts, the groove base 23 with its drive links 47. Provided between the groove base 23 and the tip of the drive link, when the saw chain 3 is in the mounted state, is a distance e, which is preferably less than 2 mm, in particular less than 1 mm, particularly preferably less than 0.5 mm. In the embodiment, the first groove depth c is adapted to the regions of the guide bar 2 at which the central section 31 has the hardened region 25 in its edge layer 24. This region is referred to in the following as the wear section 37, in which the hardened region 25 of the edge layer 24 extends in the movement direction 26 of a saw chain 3 that can be guided on the guide bar 2. The adapted first groove depth c of the guide groove 4 in the wear region 37 is less than the second groove depth d outside of the wear region 37. The adapted first groove depth c of the guide groove 4 extends over at least 20%, preferably over at least 40%, advantageously over at least 70% of the wear region 37, in particular of the redirection section 27. It may also be expedient to provide the entire wear region 37, in particular the redirection section 27, with an adapted, first groove depth c. It may also be expedient to provide the entire guide groove 4 with an adapted first groove depth c. The guide groove 4 is realized in the wear section 37 in such a manner that the saw chain 3 is supported, via its connecting links 48, on the guide surfaces 21 of the side elements 30, 30′ and, on the other hand, via its drive links 47, on the groove base 23 of the guide groove 4. Thus, the forces acting upon the guide bar 2 from the saw chain 3 are no longer transmitted solely to the guide surfaces 21, 21′, but are additionally distributed to the groove base 23 of the central section 31. In this way, the wear on the guide bar 2 can be reduced. Preferably, both a hardening of the central section 31 and an adaptation of the first groove depth c are provided, especially in the regions of the guide bar 2 in which particularly large forces act upon the guide bar 2. In the present embodiment according to FIG. 3, this applies to the entire redirection section 27. It may also be expedient to provide other sections of the guide bar 2 with an adapted first groove depth c, as well as hardening of the central section 31.

In a particularly preferred embodiment of the guide bar 2, the guide surfaces 21,21′ of the side elements 30, 30′ are hardened. The guide surfaces 21,21′ are preferably induction hardened, in particular laser hardened. In this way, the wear resistance of the side elements 30, 30′ can be increased. In the preferred embodiment, the guide surfaces 21, 21′ are hardened in the wear section 37 of the guide bar 2. However, it may also be expedient to harden the guide surfaces in further regions of the guide bar 2, in particular even completely. In a preferred embodiment of the guide bar 2, the side elements 30, 30′ have a hardening depth f that in each case extends, perpendicularly to the guide surfaces 21, 21′, at least 2 mm, preferably at least 3 mm, in particular approximately 4 mm out from the guide surfaces 21, 21′. It can thus be ensured that, when the side elements 30, 30′ are worn, the drive links 47 come to bear against the groove base 23 even before the hardened region on the side elements 30, 30′ is worn. If the saw chain 3 bears against both the guide surface 21, 21′ and the groove base 23, with further operation of the implement 1 there is uniform wear on the guide surfaces 21, 21′ and the groove base 23.

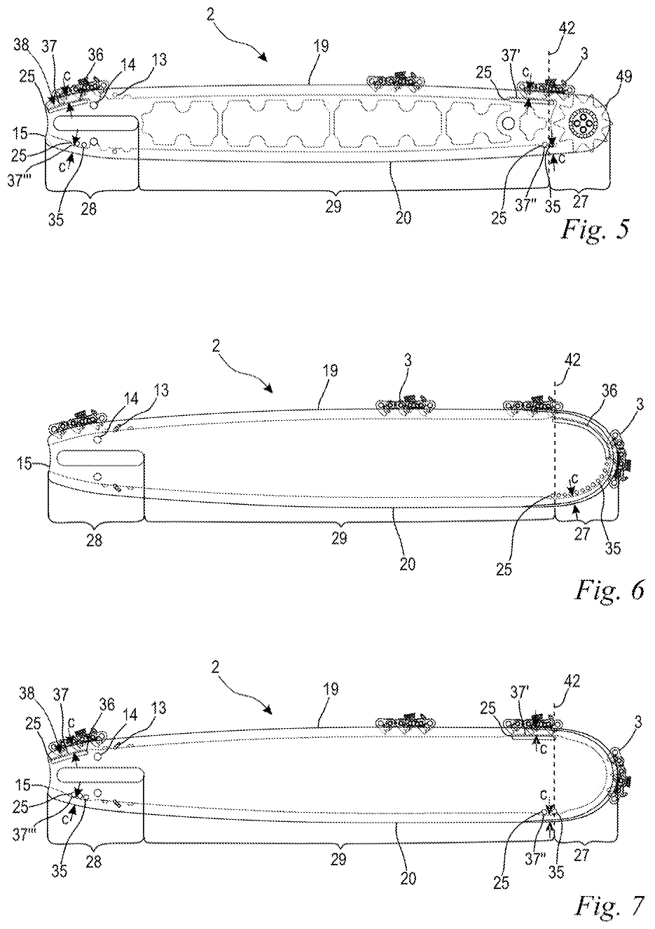

FIG. 4 shows a further embodiment, in which the edge layer 24 of the central section 31 has a plurality of hardened regions 25. Furthermore, the guide bar 2 also includes a plurality of wear sections 37, 37′, 37″, 37′″ A first wear section 37 is provided on the first longitudinal side 19 in the clamping section 28 of the guide bar 2. The saw chain 3, starting from the drive sprocket 11, is guided to the guide bar 2 and contacts the guide bar 2 in the first wear section 37, which may thus also be referred to as the run-in region 38. The first wear section 37 extends approximately from the clamping end 15 to the clamping opening 14, but without including it. A second wear section 37′ is provided on the first longitudinal side 19 of the guide bar 2 and extends from the longitudinal section 28 to the redirection section 27. The second wear section 37 in this case projects only partially into the redirection section 27 and only partially into the longitudinal section 28. The third wear section 37″ is provided on the second longitudinal side 20 of the guide bar 2. The third wear section 37″ of the guide bar 2 is located at the transition from the redirection section 27 to the longitudinal section 29. The fourth wear section 37′″ of the guide bar 2 is likewise provided on the second longitudinal side 20 of the guide bar 2. The fourth wear section 37′″ of the guide bar 2 is located in the clamping section 28 and extends only from the clamping opening 14 in the direction of the clamping end 15, the fourth wear section 37′″ ending at a distance from the clamping end 15. At this fourth wear section 37′″ the saw chain 3 is pulled by the drive sprocket 11 and is thereby lifts away from the guide bar 2. The various wear sections 37, 37′, 37″, 37′″ shown in FIG. 4 merely represent an arrangement. It may be expedient to vary the positioning of the wear sections 37, 37′, 37″, 37′″, as well as their number. Each wear section 37, 37′, 37″, 37′″ has a region 25 hardened by a weld 37, as well as the adjusted, first groove depth c. The hardness increase in the hardened region 25 is effected by laser welding, projection welding, spot welding or by a combination of the welding methods. Alternatively, the hardness increase in the hardened region may be effected, not by a welding process, but selectively by a hardening process, in particular laser hardening, preferably induction hardening. The wear sections 37, 37′, 37″, 37′″ shown in FIG. 4 show, in schematic form, various welds 34 on the first longitudinal side as well as the second longitudinal side. In principle, the guide bar 2 is realized symmetrically with respect to the longitudinal center axis 17 in the direction of view of the longitudinal plane. The longitudinal plane lies in the guide bar 2 in the direction from the first longitudinal side 19 to the second longitudinal side 20 and contains the longitudinal center axis 17. Due to the symmetrical configuration of the guide bar 2, when used in the implement it can be clamped-in in order to achieve uniform wear on the guide bar 2. Accordingly, the run-in regions 38 subject to wear are to be provided both on the first longitudinal side 19 and on the second longitudinal side 20. When the guide bar is tilted, a run-in region 38 forms a run-out region 39 that is less subject to wear (see also FIGS. 5 and 7).

FIG. 5 shows a further embodiment of a guide bar 2, in which the guide bar 2 includes a redirect sprocket 49. The redirect sprocket 49 is mounted in a rotatable manner on the redirection section 27 of the guide bar 2. The redirect sprocket 49 is located between the two side elements 30, 30′. In the redirection section 27 of the guide bar 2, the saw chain 3 is no longer guided on the guide surfaces 21, 21′ of the side elements 30, 30′, but on the redirect sprocket 49. The guide bar 2 shown in FIG. 5 likewise includes four wear sections 37, 37′, 37″, 37′″, the arrangement of which corresponds substantially to that in the embodiment of FIG. 4. The first wear section 37 extends from the clamping end 15 to the clamping opening 14. The second wear section 37′ forms a run-out region 39, since the saw chain 3 is lifted by the second wear section 37′ directly onto the guide bar 49. The third wear section 37″ forms a run-in region 38 on the second longitudinal side 20 of the guide bar 2, adjacent to the redirect sprocket 49. The fourth wear section 37′″ extends in the clamping section 28 from the clamping opening 14 in the direction of the clamping end 15, the fourth wear section 37′″ ending at a distance from the clamping end 15.

FIGS. 6 and 7 show embodiments of the guide bar 2 as a solid bar. Accordingly, the two side elements 30, 30′ and the central section 31 are realized as a single piece. The side elements 30, 30′ and the central section 31 are composed of only one material. It is therefore not necessary to join the side elements 30, 30′ to the central section 31. There is thus no need to weld the side elements 30, 30′ to the center section 31. In the preferred embodiments, therefore, the hardness increase of the hardened regions 25 is provided by laser hardening, in particular by induction hardening. Alternatively, the hardness increase may also be effected by welds. In such an embodiment, the object of the weld would be merely to increase the hardness of the central section 31, but not to form a material bond between the side elements 30, 30′ and the central section 31. If the hardness increase is achieved by welding, melting of the material is not necessary, preferably not provided, as described above. The energy input during welding is already sufficiently high below the melting temperature of the material to achieve austenitization.

The arrangement and configuration of the wear regions 37, 37′, 37″, 37′″ of the embodiment of the guide bar 2 shown in FIG.

6 corresponds to the embodiment of the guide bar according to FIG. 3. The arrangement and configuration of the wear regions 37, 37′, 37″, 37′″ of the embodiment of the guide bar 2 shown in FIG. 7 corresponds to the embodiment of the guide bar 2 according to FIG. 4.

Hardness increase, or hardening, is to be understood as an increase in hardness of the material of at least 25%. The hardened region of the central section preferably has an increase in hardness of at least 50%, preferably of at least 75%, in particular of approximately 100%, compared to the initial state of the central section. Preferably, the hardened guide surfaces 21 in the wear section 37 have an increase in hardness of at least 50%, preferably of at least 75%, in particular of approximately 100%. The hardness of the central section 31 outside of the hardened region 25 is in a range of about 150 to 250 HV10. In the preferred embodiment, the hardness of the central section 31 outside of the hardened region 25 is in the range of about 200 HV10. Preferably, the hardness in the hardened region 25 of the central section 31 is in a range of between 350 to 450 HV10, and in a particularly preferred embodiment is about 400 HV10. The side elements 30 have a base hardness, that is, a hardness outside of a hardened region, that is in a range of between 350 and 450 HV10. The base hardness is preferably 400 HV. The side elements 30 preferably have a hardness in hardened regions that is in a range of between 650 and 750 HV10. The hardness is preferably 700 HV10 in the hardened region. For solid guide bars, the stated hardness values of the side elements 30 also apply to the central section 31.

It is understood that the foregoing description is that of the preferred embodiments of the invention and that various changes and modifications may be made thereto without departing from the spirit and scope of the invention as defined in the appended claims.

What is claimed is:

1. A guide bar for a motor-driven chainsaw, the guide bar comprising:
a clamping section;
a redirection section defining a free end of said guide bar;
first and second side elements extending from said clamping section to said free end and conjointly forming said redirection section;
said guide bar having a peripheral guide groove and a middle section sandwiched between said first and second side elements to define a base of said peripheral guide groove;
said middle section having an edge layer including at least one hardened region;
said hardened region extending from a first end having a first edge layer depth (t₁) to a second end having a second edge depth (t₂);
said first edge layer depth (t₁) and said second edge layer depth (t₂) being measured orthogonally to said base of said peripheral guide groove;
said first edge layer depth (t₁) at said first end being less than said second edge layer depth (t₂) at said second end;
said second edge layer depth (t₂) at said second end being greater than one mm; and,
said first edge layer depth (t₁) at said first end of said hardened region being at most 3 mm.

2. The guide bar of claim 1, wherein the hardness increase of said at least one hardened region is effected by a weld of said guide bar.

3. The guide bar of claim 2, wherein said weld has a weld center spot at a distance (a) from said base of said peripheral guide groove with said distance (a) being less than 6 mm.

4. The guide bar of claim 1, wherein said edge layer has an edge layer depth (t_{R}) measured orthogonally to said base, said edge layer depth (t_{R}) being less than 50% of a maximum height (h) of the guide bar.

5. The guide bar of claim 1, wherein at least one of said first and second side elements and said middle section are mutually connected by a weld, said weld effecting a hardness increase of said at least one hardened region of said middle section.

6. The guide bar of claim 2, wherein said weld is a projection weld.

7. The guide bar of claim 6, wherein said projection weld is a spot weld.

8. The guide bar of claim 7, wherein said weld comprises a plurality of said spot welds, one adjacent the other with each two mutually adjacent ones thereof being spaced apart by a distance (b) of at least one of the following:
i) at most 15 mm;
ii) at most 10 mm; and,
iii) at most 7 mm.

9. The guide bar of claim 1, wherein said hardened region of said edge layer extends over a wear section in the movement direction of a saw chain guidable on said guide bar.

10. The guide bar of claim 9, wherein said peripheral guide groove of said guide bar has a first groove depth (c) in said wear section and a second groove depth (d) outside of said wear section with said first groove depth (c) being reduced compared to said second groove depth (d).

11. The guide bar of claim 10, wherein the first groove depth (c) is adapted to permit drive links of a saw chain provided for the guide bar to contact said base in said wear section.

12. The guide bar of claim 9, wherein said guide bar has a first longitudinal side and a second longitudinal side; each one of said side elements has a guide surface that extends along the longitudinal sides of the guide bar; and, said guide surfaces have a hardness increased at least in said wear section.

13. The guide bar of claim 1, wherein said edge layer of said middle section has a plurality of said hardened regions.

14. The guide bar of claim 1, wherein there is at least one hardened region realized on said redirection section.

15. The guide bar of claim 13, wherein said guide bar comprises at least one run-in region and at least one run-out region; and, a hardened region is provided on at least one of the following: i) said run-in region; and, ii) said run-out region.

16. A guide bar for a motor-driven chainsaw, the guide bar comprising:
a clamping section;
a redirection section defining a free end of said guide bar;
said guide bar being a solid bar made of a single material and extending from said clamping section to said free end forming said redirection section;
said guide bar having a peripheral guide groove and a middle portion to define a base of said peripheral guide groove;
said middle portion having an edge layer including at least one hardened region;
said hardened region extending from a first end having a first edge layer depth (t₁) to a second end having a second edge depth (t₂);
said first edge layer depth (t₁) and said second edge layer depth (t₂) being measured orthogonally to said base of said peripheral guide groove;
said first edge layer depth (t₁) at said first end being less than said second edge layer depth (t₂) at said second end;
said second edge layer depth (t₂) at said second end being greater than one mm; and,
said first edge layer depth (t₁) at said first end of said hardened region being at most 3 mm.
